(19) United States
(12) Patent Application Publication
(10) Pub. No.: US 2010/0220026 A1
(43) Pub. Date: Sep. 2, 2010

(54) Broadband Lossless Dipole Antenna

(76) Inventor: Torleif Martin, Linkoping (SE)

Correspondence Address: JACOBSON HOLMAN PLLC, 400 SEVENTH STREET N.W., SUITE 600, WASHINGTON, DC, 20004, US

(21) Appl. No.: 11/921,452

(22) PCT Filed: May 18, 2006
(86) PCT No.: PCT/SE2006/000573

§ 371 Date: May 4, 2010

(30) Foreign Application Priority Data
Jun. 2, 2005 (SE) 0501262-0

(51) Int. Cl. H01Q 9/22

(52) U.S. Cl. 343/792

(57) ABSTRACT

The present invention relates to a broadband lossless dipole antenna which is supplied at two supply points (M1, M2, S1, S2) which are symmetrically positioned along the length L of the antenna and at such a distance from each other that

$$\frac{d}{L} = 0 , 37 \pm 0 , 04.$$

The present invention relates to a broadband lossless dipole antenna. The invention has been developed based on the requirements that exist in connection with broadband low-frequency radar, especially a type called CARABAS-II which uses the frequency range 20-90 MHz and requires an antenna with a relatively great beam width. In the following discussion, reference is made to this concrete example. How-ever, the antenna can also be used in other applications where a broadband antenna with a great beam width is desired and in other applications as well, and it is Applicant's pronounced opinion that the antenna should merit protection merely based on its construction and independently of its application.

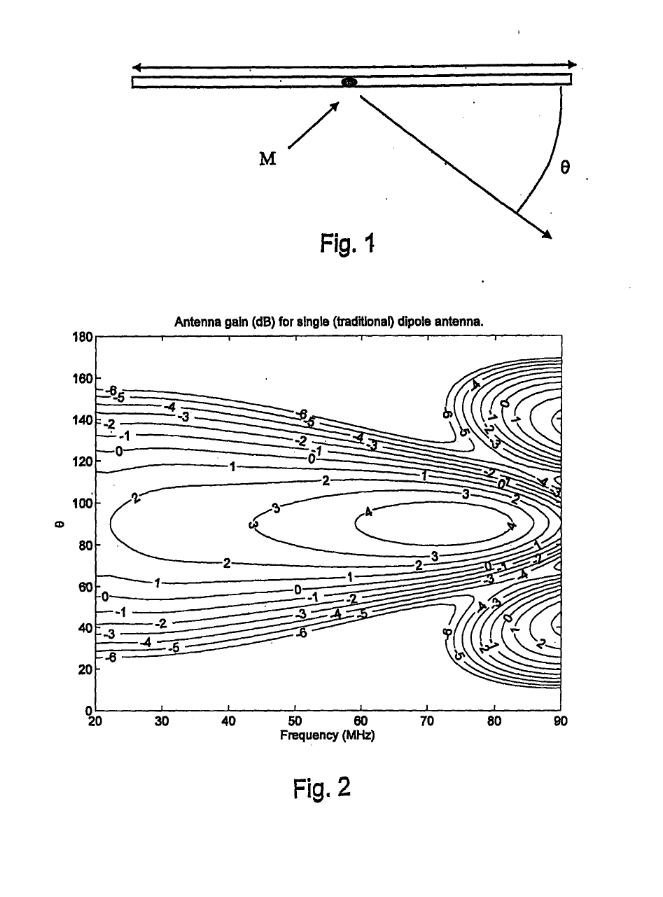

If a common dipole antenna should be used with the broadband low-frequency radar CARABAS-II, there will be problems with beam splitting at higher frequencies. FIG. 1 illustrates an example of a conventional dipole antenna with a central feeding point M, and FIG. 2 is an antenna gain chart for such a dipole antenna. The main beam, the central area with a high antenna gain, should essentially be constant over the frequency range. In the right part of the chart it is, however, to be seen that the problem with beam splitting starts to appear at about 75 MHz. A common dipole antenna thus is not suitable in the current case.

Up to now, CARABAS-II has used, instead of a common dipole, a dipole antenna in the form of a loaded slim biconical antenna, 4.9 m long. However, this antenna has an average efficiency over the frequency band of about 55% only, a higher efficiency being desirable. The reason for the low efficiency is that the antenna is provided with two filters, one on each dipole arm. The filters consist of parallel inductances, capacitances and resistances and are placed a distance onto the dipole arms. The filters prevent currents on the outer part of the dipole arms at higher frequencies, witch prevents beam splitting occurring at the higher frequencies. A great part of the power supplied to the antenna is, however, absorbed in the resistances of the filters.

The present invention solves the problem of creating an antenna that does not have beam splitting, over a broad frequency band while at the same time it functions without filters and thus achieves 100% efficiency (if the metal structure is approximated as perfectly conductive). According to the invention, this is achieved by the antenna being designed as defined in the independent claim. The remaining claims define advantageous embodiments of the invention.

The invention will now be described in more detail with reference to the accompanying drawings, in which

FIG. 1 shows an example of a conventional dipole antenna with a central feeding point M,

FIG. 2 is an antenna gain chart for the antenna in FIG. 1,

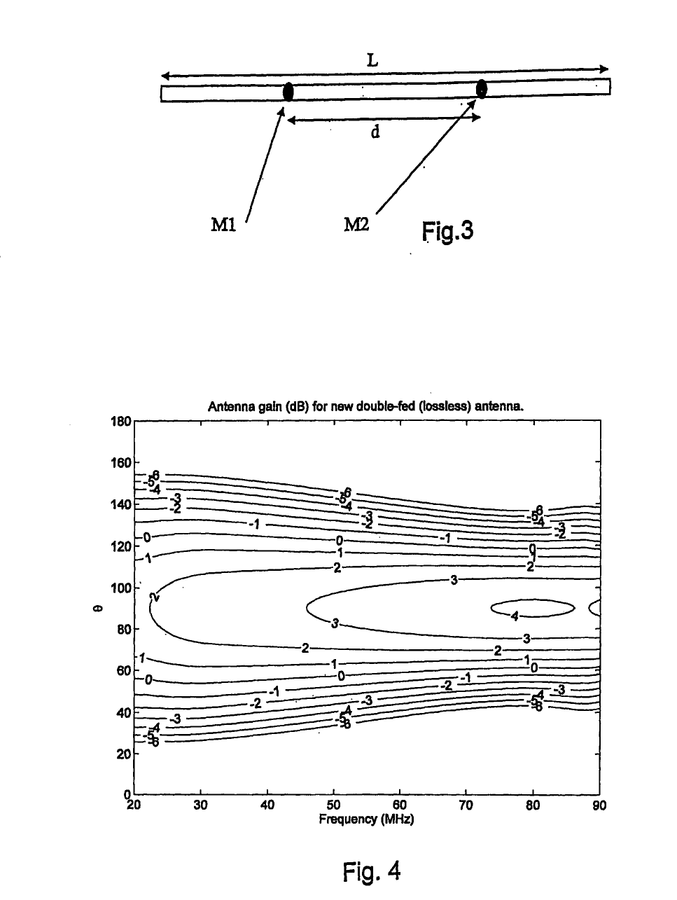

FIG. 3 is a basic sketch of an antenna according to the invention,

FIG. 4 is an antenna gain chart for the antenna in FIG. 3,

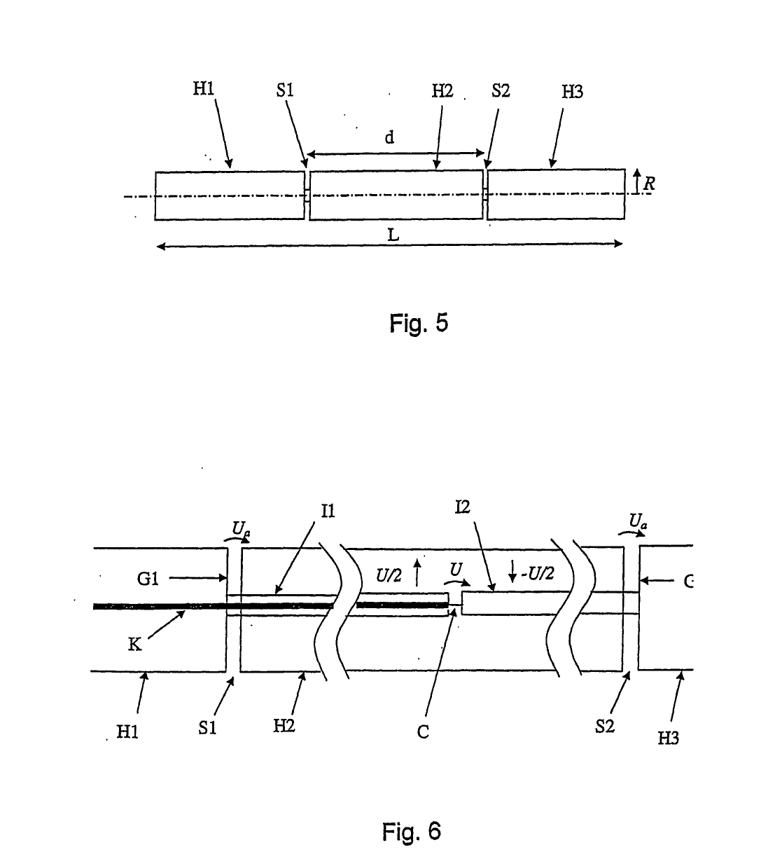

FIG. 5 is a sketch, not to scale, of an embodiment of an antenna according to the invention, and

FIG. 6 shows enlarged parts of the antenna in FIG. 5, especially around two slits in the antenna.

The basic concept of the invention involves feeding the antenna at two symmetrically positioned points M1 and M2 arranged at a certain distance from each other, see FIG. 3. The length L of the antenna, as well as the distance d between the feeding points, should according to the invention be in a certain relationship with the shortest wavelength λₘᵢₙ for which the antenna is intended. The antenna is a broadband antenna, and for a certain antenna length L, it is possible to calculate the longest wavelength λₘₐₓ for which the antenna is suited. This will be developed in the following description.

By feeding the antenna at two points according to the invention, the currents on the antenna which cause beam splitting are counteracted. There will be no losses for the antenna. FIG. 4 is an antenna gain chart for an antenna according to FIG. 3. The chart shows that there will be no beam splitting for the antenna in the desired frequency range. Since there are no loads, the efficiency of the antenna is 100% (if the metal structure is approximated as perfectly conductive).

The new dipole antenna is characterised in that it maintains a sufficient beam width over a broad frequency band. A sufficient beam width is defined as the antenna gain exceeding −1 dB within 90°±30°, that is between 60° and 120° in FIG. 3, while at the same time the antenna gain perpendicularly from the antenna (in the maximum direction) should exceed 2 dB over essentially the entire frequency band. The band width can be expressed without dimensions by relating the wavelength λ to the length L of the antenna. A traditional centrally supplied dipole satisfies the above requirements up to frequencies whose wavelength λₘᵢₙ is equal to the antenna length L, that is L/λₘᵢₙ=1.0.

An antenna according to the invention satisfies the requirements for frequencies whose wavelength λₘᵢₙ is L/λₘᵢₙ=1.35, which is great progress. At the same time the antenna can manage wavelengths up to L/λₘₐₓ˜0.3, without the radiation resistance being too low and with an antenna gain in the main beam above 2 dB. As a result, the ratio of antenna length to wavelength may vary between L/λ=0.3-1.35.

This is achieved with the double-supplied dipole if the distance d between the feeding points satisfies the condition d/λₘᵢₙ=0.50±0.03, where λₘᵢₙ is the wavelength at the highest frequency of the band. The double feeding cancels the variation of current which causes beam splitting for a common dipole. The antenna has acceptable properties as long as d/λₘᵢₙ=0.50±0.05.

The distance between the two feeding points should, according to the discussion above, be in a certain relationship with the antenna length,

$$\frac{d}{L} = 0.37 \pm 0.02 .$$

As stated above, such an antenna functions excellently for wavelengths in the range λ=L/0.3-1.35. The antenna has acceptable properties as long as

$$\frac{d}{L} = 0.37 \pm 0.04 .$$

FIGS. 5 and 6 illustrate more concretely an embodiment of the invention. As usual, the antenna has a conductive cover H1, H2 and H3, normally made of metal. In the exemplary embodiment, the cover is circular in cross-section, but may in other embodiments of the invention have a different cross-section. The radius R of the cross-section should be much smaller than the wavelength, R/λₘᵢₙ<<1. In the example of an antenna for the frequency range 20-90 MHz that will be presented below and is shown in FIGS. 5 and 6, R/λₘᵢₙ≈0.03, which corresponds to the radius R being 10 cm.

An advantageous way of feeding the antenna uses slits S1 and S2 which at the feeding points extend along the circumference of the antenna cover. The slits divide the antenna cover in the longitudinal direction into three parts, a central part H2 between the slits and an external part H1 and H3, respectively, outside the respective slits. Adjacent to the slits, the end of the external parts, which faces the centre, is covered with a conductive structure G1 and G2, which can be of different designs. In the exemplary embodiment, use is made of conductive end walls which cover the cross-section completely. In other cases, the conductive structures can be designed as radial spokes over the cross-section or in other ways. The antenna is supplied via these two end walls G1 and G2 by being in their centre each connected to an inner conductor I1 and I2 which extends along the central axis of the central part H2 of the antenna towards the centre of the antenna in the longitudinal direction, where the inner conductors practically meet, without contacting each other.

The inner conductors I1 and I2 are in the exemplary embodiment circular in cross-section with a constant radius, but may in other cases have a different cross-section and a varying radius. A varying radius can be used for the purpose of impedance matching. If the inner conductors have a constant radius and no other impedance matches are made, a suitable radius of the inner conductors is about 0.1 times the radius of the outer cover of the antenna, which in the CARABAS case means a radius of the inner conductors of about 1 cm.

The circumferential surface of the inner conductors is electrically shielding, either by the conductors having a closed conductive circumferential surface or, if they consist of a conductive mesh, by having sufficiently small meshes. An inner duct in one inner conductor I2 is used in the exemplary embodiment to hold the coaxial cable K which supplies the antenna, and by the inner conductors of the antenna having an electrically shielding circumferential surface, electric currents are prevented from occurring on the surface of the coaxial cable.

To prevent currents on the outer cover of the coaxial cable K outside the antenna, it is possible to design the coaxial cable in different ways with a choke/coil/inductance. For instance the coaxial cable can be wound on a ferrite core. The function of the antenna is not affected by this, but currents do not travel on the outer cover of the coaxial cable past the coil.

The antenna is supplied by the two inner conductors I1 and I2 at a central feeding point C being supplied from a coaxial cable K. One inner conductor I2 of the antenna is connected to the inner conductor of the coaxial cable K and the other inner conductor I1 of the antenna is connected to the outer conductor of the coaxial cable. The two inner conductors I1 and I2 of the antenna function as coaxial transmission lines together with the outer cover H2 on the central part of the antenna. The coaxial transmission lines are terminated with the slit openings S1 and S2 in the outer cover of the antenna, which are the actual radiation sources for the antenna. Half of the current U from the coaxial cable is distributed to each opening. It should be noted that the polarity in the right and the polarity in the left coaxial transmission line are opposite, which however causes voltage sources Uₐ which are directed in the same way adjacent to the slit openings. No balun is necessary at the feeding point since the construction prevents currents from returning on the outer cover of the coaxial cable at its connection point in the centre of the antenna.

The slit width should typically be much smaller than the shortest wavelength λₘᵢₙ. A suitable slit width is 0.005 to 0.010 times λₘᵢₙ which in the CARABAS case results in a slit width of about 2 cm. An upper limit where the function is impaired is a slit width of 0.1 times λₘᵢₙ.

The lower limit of the slit width mainly depends on when the capacitance over the slit becomes so great that match problems and finally flashover occur. The antenna has the desired radiation properties until this occurs. A standard value, to provide an opinion where the lower limit of the slit width may be, is 0.001 times λₘᵢₙ, which in the CARABAS case means about 2 mm. In practice, the lower slit width can be both below and above this standard value.

The antenna can in prior-art manner be provided with an impedance matching net-work which consists of reactive components. Impedance matching can occur either adjacent to the slit openings or at the feeding point in the centre of the antenna. In some embodiments of the invention, the inner conductors are cylindrical and have a radius which along its length is adjusted to the type of matching network that is used. An option is to use, as inner conductors I1 and I2, a conical conductive structure with a tip at the central feeding point C and a gradually increasing radius up to the conductive structures G1 and G2 adjacent to the slits S1 and S2. The antenna function described above is not affected by any impedance matching.

In a concrete antenna according to the invention, the cover, the end walls and the inner conductors can be made of aluminium or copper. To keep the inner conductor in the correct position, the inner conductors can be supported in the antenna cover by sheets of some dielectric material, for instance FRIGOLIT®. The coaxial cable can be of a common type for feeding antennas.

1. A broadband lossless dipole antenna, characterised in that it is supplied at two feeding points (M1, M2, S1, S2), which are symmetrically positioned along the length L of the antenna and at such a distance d from each other that
$$\frac{d}{L} = 0 , 37 \pm 0 , 04.$$

2. A dipole antenna as claimed in claim 1, characterised in that the feeding points (M1, M2, S1, S2) are arranged at such a distance d from each other that
$$\frac{d}{L} = 0 , 37 \pm 0 , 02.$$

3. A dipole antenna as claimed in claim 1, characterised in that the antenna consists of a conductive cover (H1, H2, H3), which is divided by slits (S1, S2) extending transversely to the longitudinal axis, along the circumference of the cover, into three cylindrical parts at the feeding points (M1, M2), a central part (H2) and two external parts (H1, H3), that the external parts are, at their ends facing the slits, provided with a conductive structure (G1, G2) over their cross-sections, that an inner conductor (I1, I2) extends from each conductive structure along the central axis of the central part (H2) of the antenna substantially to a central feeding point (C) of the antenna, without the inner conductors contacting each other, and that the antenna at the central feeding point is supplied by a coaxial cable (K), the inner conductor of the coaxial cable being connected to one inner conductor (I2) of the antenna and the outer conductor of the coaxial cable being connected to the other inner conductor (I1) of the antenna.

4. A dipole antenna as claimed in claim 3, characterised in that the inner conductors (I1, I2) have an electrically shielding circumferential surface and that the coaxial cable (K) extends through one end of the antenna and runs in an inner duct in one inner conductor (I2) to the central feeding point (C).

5. A dipole antenna as claimed in claim 3, characterised in that the slit width is less than 0.1 times λₘᵢₙ, where λₘᵢₙ is the shortest wavelength for which the antenna is intended.

6. A dipole antenna as claimed in claim 5, characterised in that the slit width is 0.005-0.010 times λₘᵢₙ.

7. A dipole antenna as claimed in claim 1, characterised in that the cover of the antenna is circularly symmetric with a radius R selected according to R≈0.03·λₘᵢₙ, where λₘᵢₙ is the shortest wavelength for which the antenna is intended.

8. A dipole antenna as claimed in claim 7, characterised in that the inner conductors (I1, I2) have a circular cross-section with a constant radius amounting to about 0.1 times the radius R of the outer cover of the antenna.
